(19) United States
(12) Patent Application Publication
(10) Pub. No.: US 2019/0166942 A1
(43) Pub. Date: Jun. 6, 2019

(54) HELMET HAVING DRIVING VIDEO RECORD OF 360 DEGREES

(71) Applicant: Hsing-Ming Lee, Taipei City (TW)

(72) Inventor: Hsing-Ming Lee, Taipei City (TW)

(21) Appl. No.: 15/834,009

(22) Filed: Dec. 6, 2017

(51) Int. Cl. A42B 3/04; H04N 5/232; H04N 5/247; H04N 5/225

(52) U.S. Cl. CPC A42B 3/0426; H04N 5/2253; H04N 5/247; H04N 5/23238

(57) ABSTRACT

The present invention provides a helmet having the driving video record of 360 degrees, comprising: a helmet; the first and second video cameras; and the control module. The first and second video cameras are respectively set at the horizontal, vertical or oblique diagonal positions of the helmet. The video recording angle of view whereof are both greater than 180 degrees. The control module is set in the interior of the helmet to receive and process the images of the first and second video cameras and provide electricity. Through the first and second video cameras are set at the diagonal positions of the helmet respectively and the video recording angle of view of them are both greater than 180 degrees, the 360 degree full image surrounding the helmet can be captured, shot, and recorded completely without the problem of recording dead angle of view.

### (A) TECHNICAL FIELD OF THE INVENTION

The present invention relates to a helmet having the driving video record of 360 degrees, especially relates to a helmet respectively set the first and second video cameras at the horizontal, vertical or oblique diagonal positions of the helmet. And, a control module is set in the interior of the helmet to receive and process the images of the first and second video cameras and provide electricity. Through the first and second video cameras are set at the diagonal positions of the helmet respectively and the video recording angle of view of them are both greater than 180 degrees, the 360 degree full image surrounding the helmet can be captured, shot, and recorded completely without the problem of recording dead angle of view.

### (B) DESCRIPTION OF THE PRIOR ART

Nowadays, the bicycle has been a popular riding transportation instead of walking since long time ago because of its advantages of small vehicle volume, lightness, and convenience. In addition, it is also the best equipment for exercise, leisure, and outdoor sport. Viewing the indispensable safety helmet for riding a bicycle, there has already been the safety helmet equipped with a single driving recorder to proceed the video recording function presently. It can increase the fun of outdoor shooting and record, and also increase the video recording ability for riding safety on the other hand.

Therefore, the safety helmet having a single driving recorder has been favored by the consumers. The only thing lacking is that such kind of helmet can not fulfill the full image recording ability of 360 degrees completely, especially for the shooting and record of lateral and backward images. It is indeed pitiful that it will possibly form a recording dead angle of view.

For such kind of the driving recorders of the helmet or safety helmet, they are all video recording devices of exposed types. Therefore, they will easily cause extremely uncomfortable psychological feeling for appearance and wearing.

Furthermore, they will increase the head weight of the wearer and cause the problem of gravity center. Consequently, the safety and convenience of such kind of the driving recorders of the helmet or safety helmet are keep tested and challenged, and are continuously questioned and criticized by the consumers.

### SUMMARY OF THE INVENTION

The present invention discloses a helmet having the driving video record of 360 degrees which includes a helmet, a first video camera, a second video camera, and a control module.

The first video camera is set in the interior of the helmet and the lens whereof is exposed out of the helmet, which the video recording angle of view of the first video camera is greater than 180 degrees. The second video camera is set in the interior of the helmet and the lens whereof is exposed out of the helmet, which the video recording angle of view of the second video camera is greater than 180 degrees. The second video camera and the first video camera are located at the diagonal positions of the helmet, such as at the horizontal, vertical or oblique diagonal positions. The control module which includes a control circuit unit and a battery unit is set in the interior of the helmet. The control circuit unit is electrically connected with the first video camera, the second video camera, and the battery unit respectively. And, the control circuit unit is used to receive and process the images of the first video camera and the second video camera. The battery unit provides electricity to the control circuit unit, the first video camera, and the second video camera.

The present invention is characterized in that utilizing the diagonal positions of the helmet, such as at the horizontal, vertical or oblique diagonal positions to respectively set the first video camera and the second video camera. And, the control module is set in the interior of the helmet to receive and process the images of the first video camera and the second video camera, and it provides electricity. The first video camera and the second video camera are located at the diagonal positions of the helmet respectively, and the video recording angle of view of them are both greater than 180 degrees. Such that, the 360 degree full image surrounding the helmet can be captured, shot, and recorded completely without the problem of recording dead angle of view. Meanwhile, both the first video camera and the second video camera are respectively hidden in the helmet 1, which can completely avoid the problems caused by additionally adding a driving recorder, which includes the psychogenic influence for the wearer, the heavy weight, and the instable gravity center . . . , etc.

### BRIEF DESCRIPTION OF THE DRAWINGS

FIG. 1 is a schematic diagram of the first embodiment of a helmet according to the present invention.

FIG. 2 is a schematic diagram of the second embodiment of a helmet according to the present invention.

FIG. 3 is a sectional side view of the second embodiment according to the present invention.

FIG. 4 is an application schematic diagram of the second embodiment according to the present invention.

FIG. 5 is an application schematic diagram of the first embodiment according to the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following detailed description provides a convenient illustration for implementing exemplary embodiments of the invention.

Various changes to the described embodiments may be made in the function and arrangement of the elements described without departing from the scope of the invention as set forth in the appended claims.

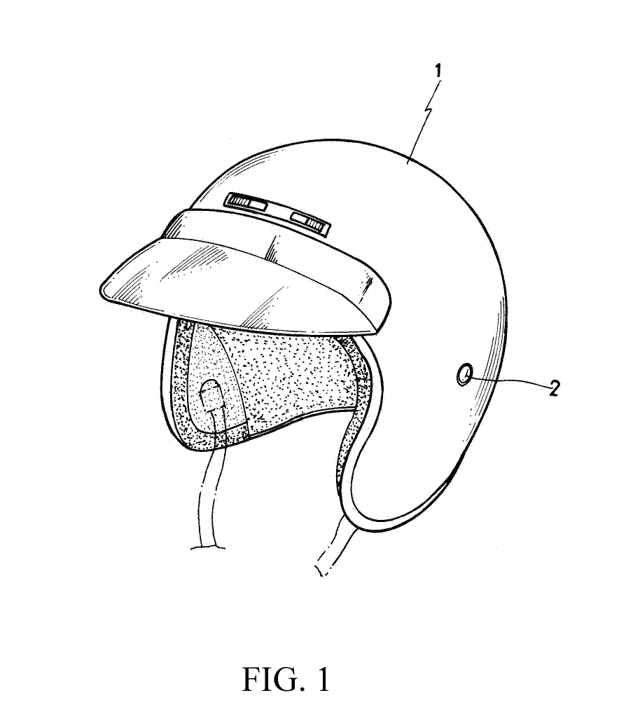

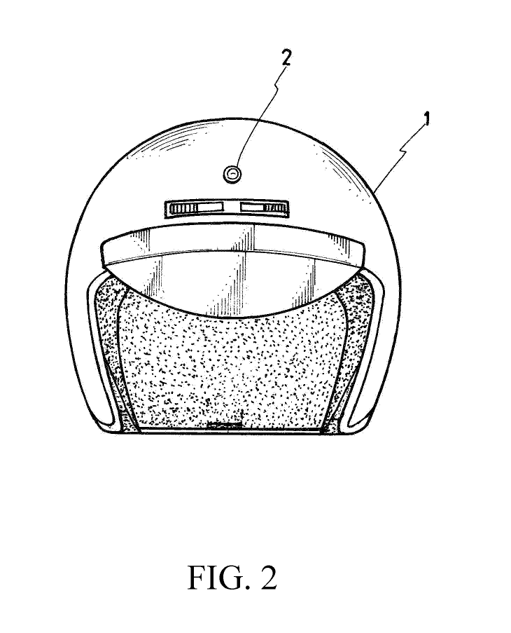

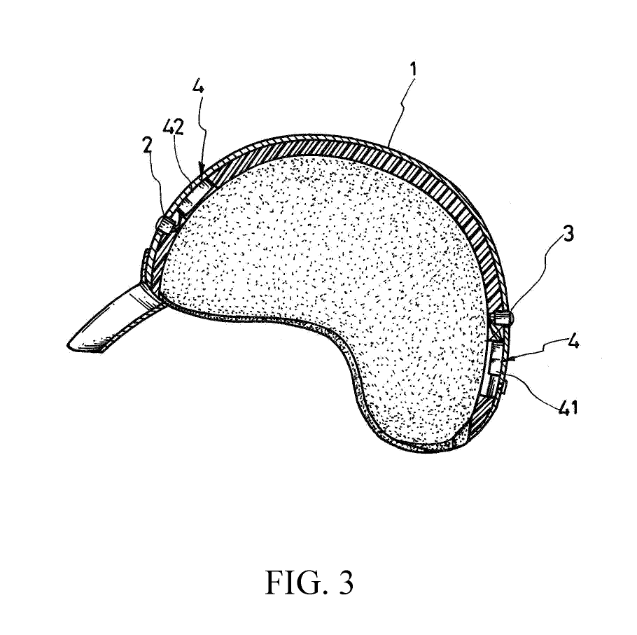

Please refer to FIG. 1 to FIG. 5, the present invention discloses a helmet having the driving video record of 360 degrees which includes a helmet 1, a first video camera 2, a second video camera 3, and a control module 4.

The helmet 1 has a default thickness and can be any kind of helmet or safety helmet without the limitation of the type.

The first video camera 2 is set in the interior of the helmet 1 and the lens whereof is exposed out of the surface of the helmet 1, which the video recording angle of view of the first video camera 2 is greater than 180 degrees, and the first video camera 2 has a first video recording area 21 within its effective video recording angle of view.

The second video camera 3 is set in the interior of the helmet 1 and the lens whereof is exposed out of the surface of the helmet 1, which the video recording angle of view of the second video camera 3 is greater than 180 degrees, and the second video camera 3 has a second video recording area 31 within its effective video recording angle of view.

Besides, the second video camera 3 is located at the diagonal or oblique diagonal position of the helmet 1, such as at the horizontal or vertical diagonal position relatively to the first video camera 2.

The control module 4 which includes a control circuit unit 41 and a battery unit 42 is set in the interior of the helmet 1. The control circuit unit 41 is electrically connected with the first video camera 2, the second video camera 3, and the battery unit 42 respectively. And, the control circuit unit 41 is used to receive and process the images of the first video camera 2 and the second video camera 3. The battery unit 42 provides electricity to the control circuit unit 41, the first video camera 2, and the second video camera 3.

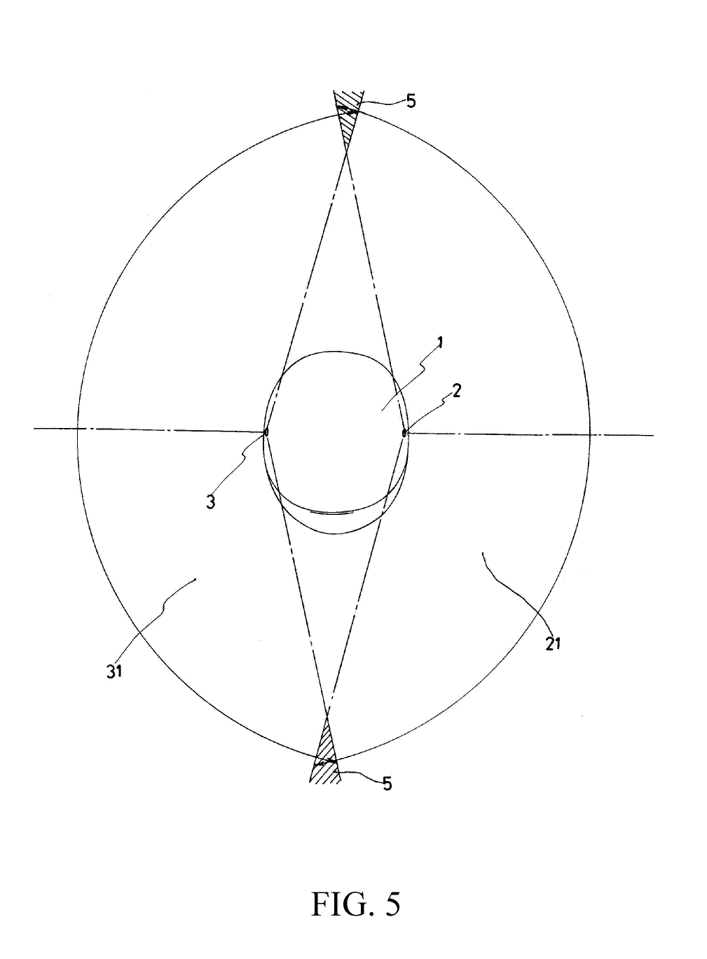

The first video camera 2 and the second video camera 3 may locate at the diagonal or oblique diagonal positions of the helmet 1 relatively. For example, the first video camera 2 and the second video camera 3 are located at the diagonal positions of the helmet 1 relatively in a vertical way as shown in FIG. 1, 2, 3, 4; such that the first video camera 2 and the second video camera 3 are located at the front and back positions of the helmet 1 relatively. Another example, the first video camera 2 and the second video camera 3 are located at the diagonal positions of the helmet 1 relatively in a lateral way as shown in FIG. 1 and FIG. 5, such that the first video camera 2 and the second video camera 3 are located at the left and right positions of the helmet 1 relatively.

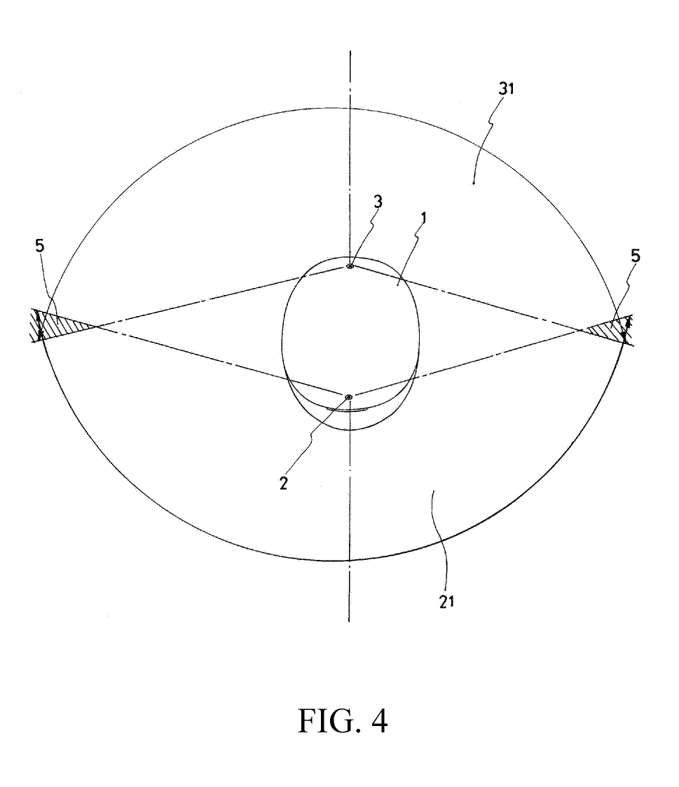

The signals shot and recorded by the first video camera 2 and the second video camera 3 can be transmitted to the control circuit unit 41 respectively for image processing and record storage. Because the video recording angle of view of the first video camera 2 and the second video camera 3 are both greater than 180 degrees, such that the first video recording area 21 of the first video camera 2 and the second video recording area 31 of the second video camera 3 will produce a partial overlapped area 5 as shown in in FIG. 4 and FIG. 5. And, the phenomenon of the overlapped area 5 can be executed by the control circuit unit 41 to make the displayed image show an image of the angle of view of 360 degrees. However, the processing method for the phenomenon of the overlapped image is not the characteristic of the present invention, so it will not be further described here.

To briefly sum up, the present invention utilize the diagonal or oblique diagonal positions of the helmet 1 to respectively set the first video camera 2 and the second video camera 3. And, the control module 4 is set in the interior of the helmet 1 to receive and process the images of the first video camera 2 and the second video camera 3, and it provides electricity. The first video camera 2 and the second video camera 3 are located at the diagonal or oblique diagonal positions of the helmet 1 respectively, and the video recording angle of view of them are both greater than 180 degrees. Such that, the 360 degree image surrounding the helmet 1 can be captured, shot, and recorded without the problem of recording dead angle of view. Meanwhile, both the first video camera 2 and the second video camera 3 are respectively hidden in the helmet 1, which can avoid the problems including the psychogenic influence for the wearer, the heavy weight, and the instable gravity center . . . , etc.

I claim:

1. A helmet having the driving video record of 360 degrees, comprising:
a helmet;
a first video camera set in the interior of the helmet, wherein the lens of the first video camera is exposed out of the helmet and the video recording angle of view of the first video camera is greater than 180 degrees;
a second video camera set in the interior of the helmet; wherein the lens of the second video camera is exposed out of the helmet and the video recording angle of view of the second video camera is greater than 180 degrees; wherein the second video camera and the first video camera are relatively located at the diagonal positions of the helmet; and
a control module set in the interior of the helmet; wherein the control module comprises a control circuit unit and a battery unit, which the control circuit unit is electrically connected with the first video camera, the second video camera, and the battery unit respectively and the control circuit unit is used to receive and process the images of the first video camera and the second video camera; wherein the battery unit provides electricity to the control circuit unit, the first video camera, and the second video camera.

2. The helmet having the driving video record of 360 degrees according to claim 1, wherein the first video camera and the second video camera are located at the diagonal positions of the helmet relatively in a vertical way.

3. The helmet having the driving video record of 360 degrees according to claim 1, wherein the first video camera and the second video camera are located at the oblique diagonal positions of the helmet relatively in a vertical way.

4. The helmet having the driving video record of 360 degrees according to claim 1, wherein the first video camera and the second video camera are located at the diagonal positions of the helmet relatively in a lateral way.

5. The helmet having the driving video record of 360 degrees according to claim 1, wherein the first video camera and the second video camera are located at the oblique diagonal positions of the helmet relatively in a lateral way.
